(19) United States
(12) Patent Application Publication
(10) Pub. No.: US 2009/0248579 A1
(43) Pub. Date: Oct. 1, 2009

(54) Method and System for Accepting and Processing Financial Transactions over a Mobile Computing Device

(76) Inventors: Ronald Kaminski, South Setauket, NY (US); Christopher Kayser, Brightwaters, NY (US); Mark Self, Cary, NC (US)

Correspondence Address: MOTOROLA, INC., 1303 EAST ALGONQUIN ROAD, IL01/3RD, SCHAUMBURG, IL, 60196, US

(21) Appl. No.: 12/058,914

(22) Filed: Mar. 31, 2008

(51) Int. Cl. G06Q 20/00; H04L 9/00

(52) U.S. Cl. 705/67; 705/72; 705/73; 705/75; 705/78; 705/17; 705/23

(57) ABSTRACT

A system includes a processing component; a communication interface receiving transaction data when a mobile device is coupled to the system; at least one data capture input element receiving payment data from an item external to the system and the mobile device; and a display displaying at least the transaction data.

### FIELD OF INVENTION

The present invention generally relates to systems and methods for accepting and processing financial transactions over a mobile computing device.

### BACKGROUND

The terms point of sale or point of service (“POS”) refer to a retail shop location, a checkout counter within a shop, or any other location where a transaction occurs. More specifically, the term POS often refers to the hardware and/or software used for checkouts (e.g., a cash register, a credit card payment terminal, etc.). For example, POS systems are in supermarkets, restaurants, hotels, stadiums, and casinos, as well as other retail establishments. Currently, payment solutions are restricted to desktop computers, tether solutions, or single use devices.

Mobile computing devices, or mobile units (“MUs”), such as barcode scanners, image-based scanners, RFID readers, radio transceivers, video cameras, etc., are used in a multitude of situations for both personal and business purposes. As the benefits of utilizing MUs expand rapidly across more industries, the features of these products expand at a corresponding pace. Accordingly, a demand exists for MUs to perform more complicated tasks in a quick, efficient and reliable manner.

### SUMMARY OF THE INVENTION

The present invention relates to a system which includes a processing component; a communication interface receiving transaction data when a mobile device is coupled to the system; at least one data capture input element receiving payment data from an item external to the system and the mobile device; and a display displaying at least the transaction data.

The present invention also relates a method which includes the following steps; receiving at a first device transaction data from a second device attached to the first device; and receiving at the first device payment data by an interactive of an input element of the first device with an item external to the first device and the second device.

### BRIEF DESCRIPTION OF THE DRAWINGS

FIG. 1 shows an exemplary embodiment of a mobile payment accessory system for accepting and processing a financial transaction according to the exemplary embodiments of the present invention.

FIG. 2 shows an exemplary system including a mobile payment accessory mounted to a mobile unit according to the exemplary embodiments of the present invention.

FIG. 3 shows an exemplary method for accepting and processing a financial transaction via a mobile payment accessory attached to a mobile unit according to the exemplary embodiments of the present invention.

### DETAILED DESCRIPTION

The present invention may be further understood with reference to the following description of exemplary embodiments and the related appended drawings, wherein like elements are provided with the same reference numerals. The present invention is related to systems and methods for accepting and processing financial transactions over a mobile computing device. Specifically, the present invention is related to a system and method for mounting a mobile payment option, such as a mobile payment accessory, onto a general-purpose handheld mobile computing device, or mobile unit (“MU”). An exemplary MU may include a personal digital assistant (“PDA”), a radio frequency identification (“RFID”) reader, a laser based scanner, an image-based scanner, a mobile telephone, a portable gaining console, a laptop, etc. Various embodiments of the present invention will be described with reference to an exemplary MU. However, those skilled in the art will understand that the present invention may be implemented with any electrical and/or mechanical hand-operated device that can be attached to a mobile payment accessory.

According to the exemplary embodiment of the present invention, the systems and method described below may adds value to an existing mobile computing device product line by allowing retailers, as well as other parties like field service personnel, to not only run the point-of-sale application, but also close out the transaction using either a debit payment or credit card payment. Furthermore, the exemplary systems and methods may add considerable value to existing products by eliminating the need for a second device, such as payment only device. Accordingly, the systems and methods may increase the return on investment that customers currently enjoy from their purchase of existing mobile computing devices.

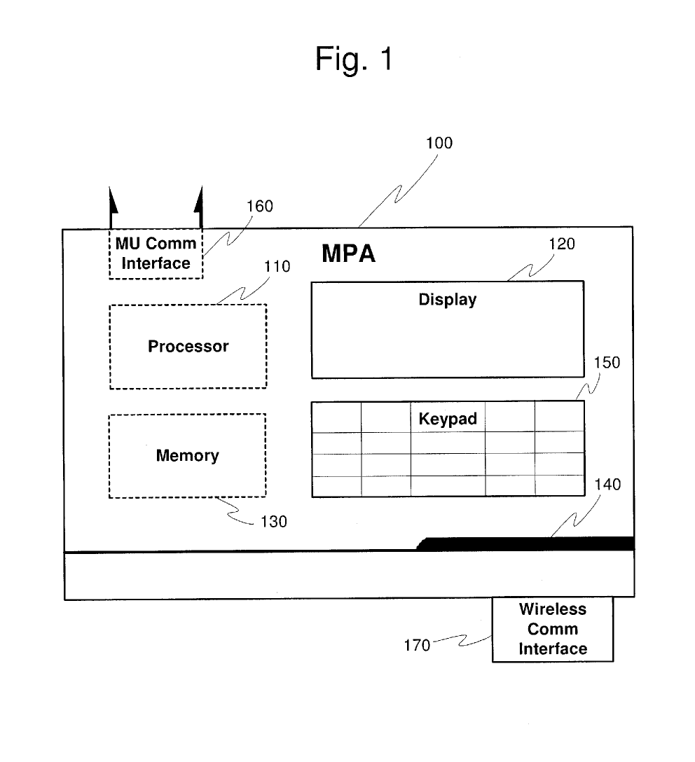

FIG. 1 is a block diagram of a mobile payment accessory (“MPA”) system 100 for accepting and processing a financial transaction. The exemplary MPA 100 may utilize a closed architecture for hardware and software configurations. Therefore, the MPA 100 may be a system wherein the technical specifications are not made public by the manufacturer. As such, third parties users may be prevented from gaining access to the configurations, as well as the stored data, of the MPA 100. For example, the MPA 100 may be used in a retail setting such as a restaurant, wherein the MPA 100 receives and processes credit card information from patrons. Accordingly, the closed architecture of the MPA 100 may prevent employees of the restaurant from accessing any confidential credit card information that is processed by the MPA 100.

As shown in FIG. 1, the exemplary MPA 100 may include a processor 110, a display screen 120 (e.g., a graphical user interface (“GIU”)), a memory 130, an automatic identification and data capture (“AIDC”) component 140 (e.g., magnetic stripe reader, smart card reader, RFID reader, etc.), a keypad 150, an MU communication interface 160, and a wireless communication interface 170. Furthermore, the MPA 100 may incorporate any number of AIDC methods. In addition, the MPA 100 may also include a printer for printing out transaction records (e.g., payment receipts).

The processor 110 may include one or more electrical components for executing a function of the exemplary MPA 110. For example, if the AIDC component 140 of the MPA 110 includes a magnetic stripe reader, then processor 110 may include an arrangement for reading data electronic captured form a magnetic reading head. Furthermore, if the AIDC component 140 of the MPA 110 further includes an RFID reader, then processor 110 may also, or alternatively, include an arrangement for receiving data from RF tags. The processor 110 may also include software components for controlling operation of the various electrical/hardware components of the MPA 100.

The processor 110 may regulate the operation of the MPA 100 by facilitating communications between the various components of the MPA 100, as well as communication between the MPA 100 and an attached mobile computing device. For example, the processor 110 may include one or more microprocessors, an embedded controller, an application-specific integrated circuit, a programmable logic array, etc. The processor 110 may perform data processing, execute instructions and direct a flow of data between devices coupled to the MPA 100 (e.g., the display screen 120, the AIDC component 140, the keypad 150, etc.). As will be explained below, in response to receiving data from the AIDC component 140, the processor 110 may communicate this data to an attached mobile computing device via the MU communication interface 160, and/or may communicate this data to a remote device via the wireless communication interface 170.

The display screen 120 may be a GUI that displays viewable data images generated by the processor 110. For example, the display screen 120 may include a touch screen. Specifically, a display screen 120 implemented as a touch screen serves as an input device that may supplement the keypad 150 and/or a pointing device (e.g., a mouse). Therefore, the touch screen may allow the user to interact with the GUI via a stylus or the user's finger. For example, a user may input a personal identification number (“PIN”) via a digital representation of a keypad on the display screen 120. While an exemplary display screen 120 may function as a touch screen, alternative embodiments of the MPA 100 may allow the user to input the PIN via the keypad 150. In addition, an exemplary display screen 120 may also include an electronic signature capture module for receiving a digital signature of a card user.

The memory 130 may be any storage medium capable of being read from and/or written to by the processor 110. The memory 130 may include any combination of volatile and/or nonvolatile memory (e.g., RAM, ROM, EPROM, Flash, etc.). In addition, the memory 130 may also include one or more storage disks such as a hard drive. Accordingly, the memory 130 may be a temporary memory in which data (e.g., captured data, verification data, etc.) may be temporarily stored until it is transferred to a different storage location (e.g., via the MU communication interface 160 and/or the wireless communication interface 170). In another embodiment, the memory 130 may be a permanent memory comprising an updateable database.

As described above, the AIDC component 140 may include one or more modules for electronically capturing data. These modules may include, but are not limited to, magnetic stripe readers (or magnetic read heads), smart card readers, RFID readers, etc. Furthermore, the AIDC component 140 may also include a verification module 131 for verifying the captured data, and an encryption/decryption module 132 for encrypting and decrypting the captured data. The AIDC component 140 may capture data such as a credit card/debit card number, an expiration date, a credit limit amount, card usage, a merchant ID, etc. It should be noted that the AIDC component 140 may also employ a biometric reader, wherein the reader captures biometric data. In addition, the AIDC component 140, such as the smart card reader, may execute a sequence of encrypted communications between the AIDC component 140 and a received card. Once the card is verified, any transactions carried out may be encrypted in order to prevent any unauthorized access to the transaction data. Accordingly, data from credit cards, debit cards, as well as other financial or identification media (e.g., retail reward/loyalty cards, employment IDs, driver's licenses, etc.) may be forwards to the MU communication interface 160 and/or the wireless communication interface 170 for further processing.

The keypad 150 of the exemplary MPA 100 may be used to receive a PIN from the user. The PIN may be shared between the user and a validating system in order to authenticate the user to the system. For example, the verification system may authorize the received PIN as well as the purchase itself. The verification system may be a local component within the MPA 100. Alternatively, the verification system may be a remote component, such a bank, to verify sufficient funds or credit is available to the user. Accordingly, the confidential PIN may be encrypted by the encryption/decryption module 132 and stored locally in the memory 130 or stored remotely in a database. Upon receiving the PIN from the keypad 150, the MPA 100 may look up the PIN based upon other captured data (e.g., debit card number, user ID, etc.) and then compare the received PIN with PIN stored in the database. Thus, the user may be authenticated when the number entered matches with the number stored in the system. Alternatively, the PIN may be encrypted on an item (e.g., debit card, an RFID tag, etc.) received by the AIDC component 140.

According to the exemplary embodiments of the present invention, the MU communication interface 160 allows the MPA 100 to be attached to a receiving MU 200, thereby creating a connection in which data may be exchanged between the devices. Specifically, the MU communication interface may include one or more electrical contacts for attaching the MPA 100 to an MU 200. For example, the contacts may comprise one or more sets of input/output (I/O) pins, such as a Universal Serial Bus (USB) port, a serial port, etc. In addition, the MU communication interface 160 may provide power and/or data transfer capabilities to a conventional (e.g., legacy) accessory device. Furthermore, the wireless communication interface 170 may transmit and receive wireless data to/from the remote device, such as, for example, a centralized data processing device (e.g., a data collection point) capable of collecting credit authentication data and providing payment guarantees. In one embodiment, the wireless communication interface 170 is a radio frequency (“RF”) arrangement that utilizes a wireless communication protocol (e.g., a Bluetooth protocol, an IEEE 80.1× protocol, a WAN Protocol, etc.).

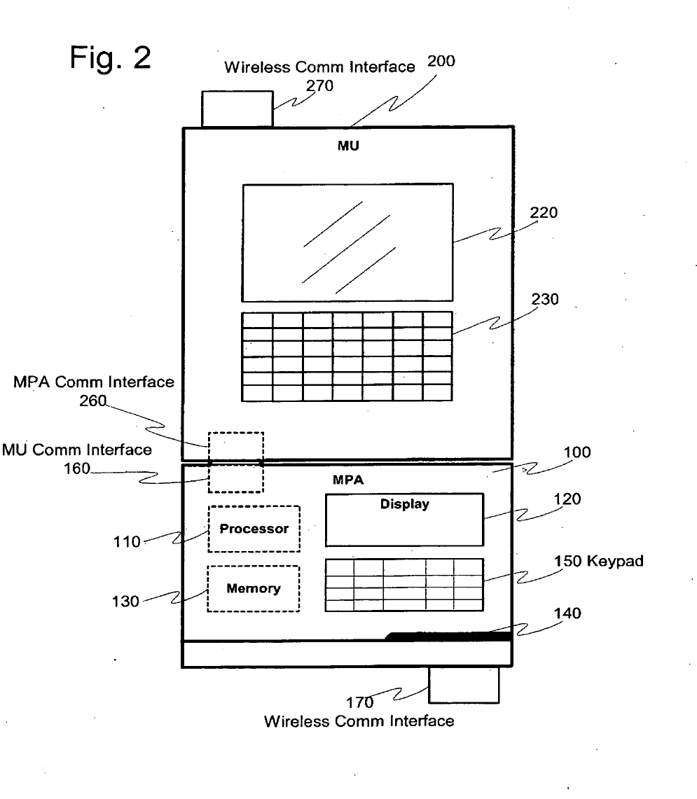

FIG. 2 shows an exemplary system comprising an MPA 100 mounted to an MU 200 according to the exemplary embodiments of the present invention. As described above, the MU 200 may be a general-purpose handheld computing device, such as a PDA. According to one embodiment of the present invention, the exemplary MU 200 may be used by a package delivery service. For example, the MU 200 may be capable of scanning a barcode of package and or delivery receipt. It may also capture a signature of a customer. Alternatively, the MU 200 may gather a food and drink order in a restaurant. For example, the MU 200 may store and display a list of menu items and allow a user to select items ordered by a customer. Furthermore, the MU 200 may be used in a retail setting in order to bring the POS to customers waiting in line (e.g., for “line-busting” purposes). For example, the MU 200 may scan, or otherwise select, the item for purchase by the customer.

As opposed to the closed architecture of the MPA 100, the exemplary MU 200 may utilize an open architecture for hardware and software configurations, thereby allowing users to add, upgrade, and/or swap components of the MU 200. As such, the open architecture of the MU 200 may allow users to see inside each of the components of the architecture without any proprietary constraints. Accordingly, the MU 200 may include a display screen 220 (e.g., a liquid crystal display) and an input component 230 (e.g., a keypad). Similar to the display screen 120 of the MPA 100, the display screen 220 of the MU 200 may be capable of receiving additional user input (e.g., touch-screen input). Thus, the user may enter input using the keypad 230 and/or the display 220. As described above, additional input devices (e.g., a barcode scanner, a signature capturing component, etc.) may also be included within the MU 200. Furthermore, the MU 200 may include a printer for printing out transaction records (e.g., payment receipts).

Furthermore, the MU 200 may include an MPA communication interface 260. For example, the MPA communication interface 260 may include one or more electrical contacts disposed on a side (e.g., a proximal end) of the MU 200. Accordingly, the MPA communication interface 260 may connect directly to the MU communication interface 160 of the MPA 100 and may transfer power and/or data between the MU 200 and the MPA 100. However, it should be noted that the MPA 100 may be a self-powered device and/or may receive power wirelessly (e.g., via induction) from the MU 200 or a further source.

The MU 200 may include a receiving arrangement for detachably coupling to the MPA 100. For example, the receiving arrangement may comprise one or more slots selectively coupled to one or more corresponding interlocking tabs located on a housing of the MPA 100. The receiving arrangement may also be located on the MPA 100, and the tabs located on the MU 200. The slots may be shaped to complement the tabs, allowing the MPA 100 to be snapped into place. Alternatively, tabs may be placed on a housing of the MU 200 while the receiving arrangement is disposed on the housing of the MPA 100. Those of skill in the art will understand that the MU 200 may utilize any mechanism for detachably receiving the MPA 100 including, but not limited to, screws, hooks, clasps, adhesives, Velcro®, magnets, etc.

In the attached configuration, as shown in FIG. 2, the receiving arrangement of the MU 200 may be mated to a receiving arrangement of the MPA 100 in order to securely maintain both a mechanical and an electrical connection between the two devices. Although the exemplary embodiments described herein utilize an externally coupled accessory device, other embodiments may include accessory devices that are internally coupled to the MU 200. For example, in one embodiment, the MU 200 may include a compartment for receiving the MPA 100, which may be placed therewithin by sliding, snapping, rotating, etc. Thus, the MPA 100 may be partially or fully received within the housing of the MU 200.

According to one exemplary embodiment of the present invention, the MU 200 may include a wireless communication interface 270 for the transmission and reception of wireless data to/from a remote device, such as, for example, a centralized data processing device capable of collecting credit authentication data and providing payment guarantees. Similar to the wireless communication interface 170 of the MPA 100, the wireless communication interface 270 of the MU 200 may be a radio frequency (“RF”) arrangement that utilizes a wireless communication protocol (e.g., a Bluetooth protocol, an IEEE 802.1× protocol, a WAN Protocol, etc.). Accordingly, the MPA 100 may utilize the connectivity of the MU 200 in order to transmit captured data to a centralized collection point.

While in the attached configuration, data may transfer between the MPA 100 and the MU 200. For example, the MU 200 may transfer sales items or package information to the MPA 100 for bill generation. As described above, the MPA 100 may accept and process payment information. Therefore, once payment has been authenticated, the MPA 100 may transfer receipt information to the MU 200. Furthermore, it should be noted that any transfer of data may be prevented unless the MPA 100 is attached to the MU 200. This may be accomplished by, for example, having the MPA 100 monitor the MU communication interface 160 to determine if the MU 200 is attached. In another exemplary embodiment, the accessory device 160 monitors whether it is attached to the MU 100 and only enables the wireless communication arrangement 170 when it is determined that the accessory device 160 is attached to the MU 100.

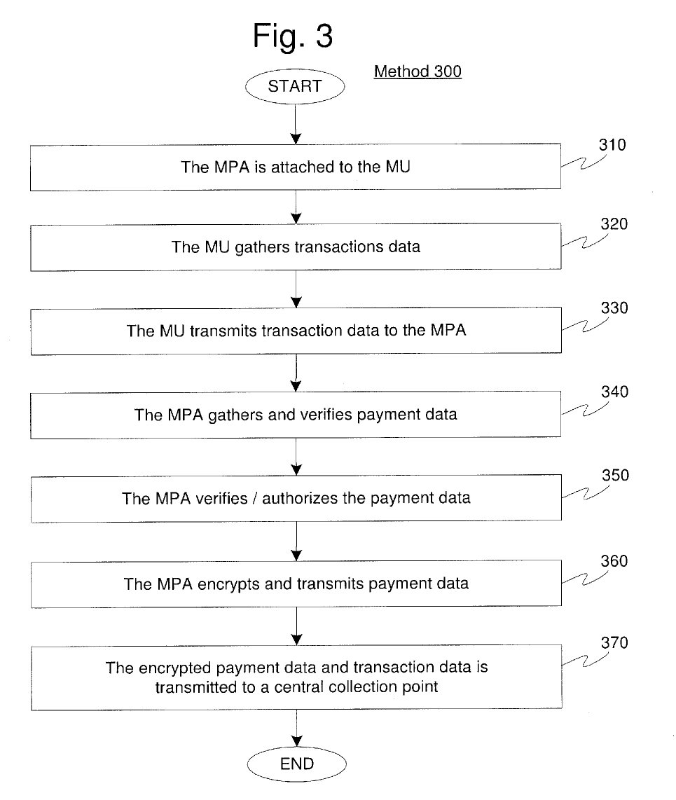

FIG. 3 shows an exemplary method 300 for accepting and processing a financial transaction according to the exemplary embodiments of the present invention. The exemplary method 300 will be described with reference to the exemplary systems of FIGS. 1 and 2. As described above, the exemplary MPA 100 may be attached to (e.g., snapped on to) the MU 200 in order to transfer data between the two devices. The MPA 100 may include the display 120, the AIDC component 140 (e.g., a magnetic head reader, smart card reader, etc.), and the keypad 150 for receiving payment information from a customer. Accordingly, the exemplary method 300 considerably streamlines the business process for taking an order anywhere within a retail environment, such as at a “point-of-decision,” as opposed to the front-end check stand. In other words, the exemplary method 300 may mobilize the point-of-sale location, thereby untethering the retail transactions. As described above, the exemplary embodiments allow retailers to not only run a point-of-sale application at the point-of-decision, but then also allow the retailer to close out the transaction through either debit card payment or credit card payment.

In step 310, the MPA 100 may be attached to the MU 200. As described, both the MPA 100 and the MU 200 may include receiving arrangements (e.g., tabs, slots, etc.) for detachably coupling to provide a mechanical connection between the two devices. In addition, the MU communication interface 160 of the MPA 100 may connect with the MPA communication interface 260 of the MU 200 to provide an electronic connection between the two devices. Therefore, data may be exchanged between the MU 200 and the MPA 100 while the devices are securely attached to one another. Furthermore, the MPA 100 may be capable of detecting the connection with the MU 200. Accordingly, data may be transmitted from the MPA 100 to the MU 200 when the connection is detected.

In step 320, the MU 200 may gather transaction data. Depending on the specific applications in which the MU 200 is implemented, the transaction data gathered by the MU 200 may include, but is not limited to, retail inventor data, restaurant menu data, packet delivery data, personal identification data, etc. Furthermore, the transaction data may be gathered via any number of components on the MU 200. For example, the data may be entered on a keypad, a touch screen, a signature capture component, a barcode scanner, etc. As the MU 200 gathers, the transaction data, the data may be presented to the user over the display screen 220 for confirmation and/or for applying any changes to the data.

In step 330, the MU 200 may transmit the transaction data to the MPA 100. As described above, once the MPA 100 is in communication with the MU 200, the transaction data may be received by the MPA 100. While the exemplary embodiment describes the data as being transmitted over a wired connection between the MU communication interface 160 of the MPA 100 may connect with the MPA communication interface 260 of the MU 200, an alternative embodiment may allow for data to transmitted from the MU 200 to the MPA 100 (and vice versa) via a wireless connection (e.g., via the wireless communication interface 170).

In step 340, the MPA 100 may gather and verify payment data from a customer. Specifically, the AIDC component 140 of the MPA 100 may receive input from a compatible source. As described above, one embodiment of the AIDC component 140 may be a head-based magnetic reader. Accordingly, the compatible source of input may be a credit card, a debit card, or any item including a magnetic stripe. An alternative embodiment of the AIDC component 140 may be an RFID reader. Accordingly, the compatible source of input may be an RFID tag, a smart card, or any item emitting RF radiation. Furthermore, the verification module 131 of the MPA 110 may verify any protected portions of the payment data, such as PIN information, credit card numbers, etc.

In step 350, the MPA 100 may authorize the payment data. Specifically, the verification module 131 of the MPA 100 may verify the captured payment data. As described above, the keypad 150 of the MPA 100 may receive a user's PIN and look up the PIN based upon other captured data (e.g., debit card number, user ID, etc.). The verification module 131 may then compare the received PIN with PIN stored in the database. For example, the MPA 100 may utilize the wireless communication interface 170 to contact a credit verification center. The verification center may collect credit/authentication request from various retailers and provide the retailers with a payment guarantee. Alternatively, the MPA 100 may utilize the connectivity of the MU 200 to contact the credit verification center. For example, a wireless communication interface of the MU 200 may be used to transmit and receive verification data between the MPA 100 and the credit verification center. It should be noted that any verification data transmitted to and from the MU 200 may be encrypted by either the MPA 100 or the credit verification center. Accordingly, the user may be authenticated when the PIN entered into the keypad 150 of the MPA 100 matches with the number stored in the system. Alternatively, the PIN may be encrypted directly on the compatible source of input (e.g., the PIN is encrypted within the debit card, an RFID tag, etc.) received by the AIDC component 140.

In step 360, the MPA 100 may encrypt and transmit the authorized payment data to the MU 200. Specifically, the encryption/decryption module 133 of the MPA 100 may encrypt the verified payment data. The verified payment data may be displayed on the displayed screen 220 of the MU 200 for payment confirmation. Furthermore, for security measures, the MPA 100 may omit specific portions of the payment data. For example, the MPA 100 may only transmit the last four digits of a credit card number, a driver's license, a social security number, a banking account number, etc. Due to the open architecture of the MU 200, the MPA 100 may prevent certain unencrypted data (e.g., financially and/or personally sensitive information) from being received and stored on the MU 200. Thus, the MPA 100 may be capable of performing the acceptance and processing of the financial and/or personal data from a customer.

In step 370, the encrypted payment data and the transaction data may be transmitted to a central collection point for any further processing and storage. Specifically, the central collection point may be separate from the credit verification center. Accordingly, this transmission may be performed in order to maintain accurate record keeping (e.g., inventory, accounting, etc.). For example, in the retail business, the centralized collection point may be real-time inventory list of items stocked within a store. Thus, any purchases made at the store may result in a change in inventory, as well as a corresponding adjustment in the financial record keeping of the business. As described above, the MPA 100 may include a wireless communication interface 170. Thus, the transmission of the data may be performed directly from the MPA 100. Alternatively, the transmission may be performed via a wireless communication interface of the MU 200.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
receiving at a first device transaction data from a second device attached to the first device; and
receiving at the first device payment data by an interactive of an input element of the first device with an item external to the first device and the second device.

2. The method according to claim 1, further comprising:
authenticating the payment data; and
encrypting the payment data.

3. The method according to claim 2, further comprising:
transmitting the encrypted payment data to one of the attached device and a credit verification center.

4. The method according to claim 1, further comprising:
transmitting the payment data and the transaction data to a collection point.

5. The method according to claim 1, wherein the payment data includes a personal identification number (“PIN”).

6. The method according to claim 4, further comprising:
verifying the PIN with a one of a local database and a remote database.

7. The method according to claim 1, wherein the input element includes at least one of a keypad, a magnetic head reader, an RFID reader, a barcode scanner, an image-based scanner, and a laser-based scanner.

8. The method according to claim 1, wherein the item is one of a credit card, a debit card, a smart card, a package, a driver's license, employment identification, a retail reward/loyalty card, and biometric data.

9. The method according to claim 3, wherein transmitting the encrypted payment data to one of the second device and a credit verification center is performed by a wireless communication interface.

10. A system, comprising:
a processing component;
a communication interface receiving transaction data when a mobile device is coupled to the system;
at least one data capture input element receiving payment data from an item external to the system and the mobile device; and
a display displaying at least the transaction data.

11. The system according to claim 10, further comprising:
a keypad receiving authentication data from a user; and
a verification component verifying the payment data and the authentication data.

12. The system according to claim 11, wherein the authentication data includes a personal identification number (“PIN”), the PIN verifying with a one of a local database and a remote database.

13. The system according to claim 10, further comprising:
an encryption module encrypting the payment data.

14. The system according to claim 13, further comprising:
a wireless communication module transmitting the encrypted payment data to a credit verification center.

15. The system according to claim 10, wherein the input element includes at least one of a keypad, a magnetic head reader, an RFID reader, barcode scanner, an image-based scanner, and a laser-based scanner.

16. The system according to claim 10, wherein the item is one of a credit card, a debit card, a smart card, a package, a driver's license, employment identification, a retail reward/loyalty card, and biometric data.

17. A device, comprising:
a transaction receiving means for receiving transaction data input initially into an attached device;
an input receiving means; and
a payment receiving means for receiving payment data from an item via the input receiving means.

18. The device according to claim 17, further comprising:
an authentication means for authenticating the payment data; and
an encryption means for encrypting the payment data.

19. The device according to claim 17, further comprising:
a transmission means for transmitting at least one of (a) the encrypted payment data to one of the attached device and a credit verification center and (b) the payment data and the transaction data to a collection point.

20. The device according to claim 17, wherein the payment data includes a personal identification number (“PIN”).

21. The device according to claim 17, further comprising:
a verification means for verifying the PIN within a one of a local database and a remote database.

22. The device according to claim 17, wherein the input means includes at least one of a keypad, a magnetic head reader, an RFID reader, barcode scanner, an image-based scanner, and a laser-based scanner.

23. The device according to claim 17, wherein the item is one of a credit card, a debit card, a smart card, a package, a driver's license, employment identification, a retail reward/loyalty card, and biometric data.
